(19) United States
(12) Patent Application Publication
(10) Pub. No.: US 2026/0111103 A1
(43) Pub. Date: Apr. 23, 2026

(54) METHOD OF GENERATING STICKER, ELECTRONIC DEVICE, AND MEDIUM

(71) Applicant: Beijing Zitiao Network Technology Co., Ltd., Beijing (CN)

(72) Inventors: Linchi LIU, Beijing (CN); Junjie LIU, Beijing (CN); Chengcai GAO, Beijing (CN)

(21) Appl. No.: 19/249,748

(22) Filed: Jun. 25, 2025

(30) Foreign Application Priority Data
Oct. 21, 2024 (CN) 202411472448.3

(51) Int. Cl. G06F 3/04845; G06F 3/04842; G06F 3/04847

(52) U.S. Cl. CPC G06F 3/04845; G06F 3/04842; G06F 3/04847

(57) ABSTRACT

The present disclosure relates to the technical field of computer vision, and discloses a method of generating a sticker, an electronic device, and a medium. The method of generating a sticker includes: obtaining a first model parameter associated with a sticker to be created; determining, from a plurality of preset sticker capabilities, a target sticker capability configured to the sticker to be created according to a creation requirement of the sticker to be created; updating the first model parameter based on the target sticker capability to obtain a second model parameter; generating a first target sticker corresponding to the sticker to be created by rendering of the second model parameter.

### CROSS-REFERENCE TO RELATED APPLICATIONS

The present application claims priority to Chinese Patent Application No. 202411472448.3, filed on October 21, 2024, which is incorporated herein by reference in its entirety as a part of the present application.

### TECHNICAL FIELD

The present disclosure relates to the technical field of computer vision, and particularly to a method of generating a stickers, devices, electronic device, media, and products.

### BACKGROUND

Sticker added to the specified media data can improve the visual effect of the specified media data and enhance the expression ability of the content.

In related technologies, the configuration and generation process of sticker is relatively independent, and when sticker needs to be increased in batches, it will lead to repeated configuration of some sticker capabilities, thereby affecting the configuration efficiency of sticker.

### SUMMARY

In a first aspect, the present disclosure provides a method of generating a sticker, the method including:

obtaining first model parameters of a sticker to be created;

determining, from a plurality of preset sticker capabilities, a target sticker capability configured to the sticker to be created according to a creation requirement of the sticker to be created;

updating the first model parameter based on the target sticker capability to obtain a second model parameter; and

generating a first target sticker corresponding to the sticker to be created by rendering of the second model parameter.

In a second aspect, the present disclosure provides a sticker generating apparatus, the apparatus including:

obtaining module configure to obtain first model parameter associated with a sticker to be created;

a configuration module configured to determine, from a plurality of preset sticker capabilities, a target sticker capability configured to the sticker to be created according to a creation requirement of the sticker to be created;

a first update module configured to update the first model parameter based on the target sticker capability to obtain second model parameter; and

a rendering module configured to generate a first target sticker corresponding to the sticker to be created by rendering the second model parameter.

According to a third aspect, the present disclosure provides an electronic device, including: a memory and at least one processor, the memory and the at least one processor are communicatively connected to each other, computer instructions are stored in the at least one memory, and the at least one processor executes the method of generating the sticker according to the first aspect or any one of the corresponding embodiments thereof by executing the computer instructions.

According to a fourth aspect, the present disclosure provides a computer-readable storage medium in which computer instructions are stored on the computer-readable storage medium for causing a computer to execute the method of generating the sticker of the first aspect or any corresponding embodiment thereof.

According to a fifth aspect, the present invention provides a computer program product including computer instructions for causing a computer to perform the method of generating the sticker according to the first aspect or any corresponding embodiment thereof.

### BRIEF DESCRIPTION OF DRAWINGS

In order to more clearly explain the specific embodiments of the present disclosure or the technical solutions in the prior art, the accompanying drawings that need to be used in the description of the specific embodiments or the prior art will be briefly introduced below, and it is obvious that the accompanying drawings in the following description are some embodiments of the present disclosure, and for those skilled in the art, other accompanying drawings can be obtained from these accompanying drawings without making creative efforts.

FIG. 1 is a schematic flowchart of a method of generating a sticker according to an embodiment of the present disclosure.

FIG. 2 is a schematic flowchart of another method of generating a sticker according to an embodiment of the present disclosure.

FIG. 3 is a schematic diagram of sticker display provided according to an embodiment of the present disclosure.

FIG. 4 is a schematic diagram of another sticker display provided according to an embodiment of the present disclosure.

FIG. 5 is a schematic structural diagram of a sticker frame according to an embodiment of the present disclosure.

FIG. 6 is a schematic diagram of a frame principle provided according to an embodiment of the present disclosure.

FIG. 7 is a structural block diagram of a sticker generating apparatus according to an embodiment of the present disclosure.

FIG. 8 is a schematic diagram of a hardware structure of an electronic device according to an embodiment of the present disclosure.

### DETAILED DESCRIPTION

In order to make the purpose, technical solutions, and advantages of the embodiments of the present disclosure more clear, the technical solutions in the embodiments of the present disclosure will be clearly and completely described below with reference to the accompanying drawings in the embodiments of the present disclosure, and it is obvious that the described embodiments are part of the embodiments of the present disclosure, but not all the embodiments. Based on the embodiments in the present disclosure, all other embodiments obtained by those skilled in the art without making creative efforts belong to the scope of protection of the present disclosure.

In the related art, the configuration and generation process of sticker is relatively independent. That is, each newly generated sticker needs to be developed separately. However, since some sticker capabilities between stickers are the same, when sticker is created in batches, some sticker capabilities will be repeatedly developed, which will not only waste resources, but also affect the configuration efficiency of sticker.

In view of this, embodiments of the present disclosure provide a method of generating a sticker, which can make the configuration mode of sticker capabilities more flexible and convenient, effectively reduce the occurrence of repeated development and configuration, and thus effectively improve the configuration efficiency of sticker.

According to an embodiment of the present disclosure, an embodiment of a method of generating a sticker is provided, and it should be noted that steps illustrated in the flowchart of the drawings may be executed in a computer system such as a set of computer-executable instructions, and although a logical sequence is illustrated in the flowchart, in some cases, the steps illustrated or described may be executed in an order different from that herein.

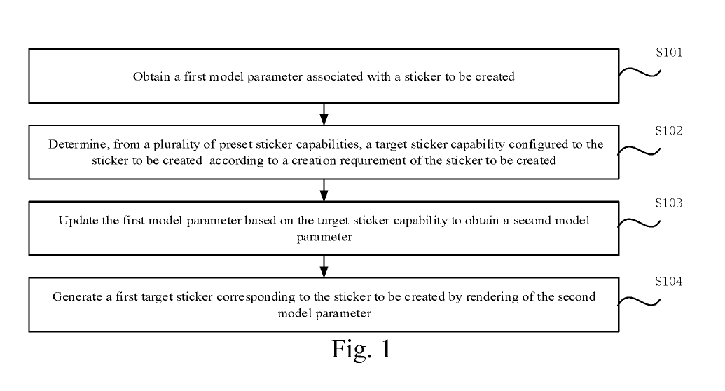

In this embodiment, a method of generating a sticker is provided, which may be used in electronic device, such as mobile phones, tablet computers, etc. FIG. 1 is a flowchart of a method of generating a sticker according to an embodiment of the present disclosure, and as shown in FIG. 1, the flow includes the steps S101 to S104.

In step S101, a first model parameter associated with a sticker to be created is obtained.

The first model parameter can be understood as a model parameter corresponding to a sticker model for generating and processing sticker. Through this parameter, the basic characteristics and attributes of the sticker to be created can be represented, such as the appearance, behavior and interaction characteristics of the sticker to be created.

In one example, the sticker model corresponding to the sticker to be created may be obtained by digital design software, 3D modeling software, or by scanning the physical object. For example: digital design software may include: Adobe Illustrator, Photoshop, and 3D modeling software may include Blender, Maya, etc. In another example, the first model parameters may be created by design software or other tools, or obtained from an existing sticker model. Design software may include: Adobe Illustrator, Photoshop, 3D modeling software, etc.

By using a corresponding tool or interface to read and obtain the first model parameter associated with a sticker to be created, the sticker object to be created and generated at present may be clarified, and then targeted configuration may be performed later.

In step S102, a target sticker capability configured to the sticker to be created is determined from a plurality of preset sticker capabilities according to the creation requirement of the sticker to be created.

According to the creation requirements of the sticker to be created, specific creation requirements and expectations for generating the sticker to be created may be clarified, and then sticker capabilities to be configured for the sticker to be created may be determined therefrom. Among them, sticker capabilities refer to the features and/or functions of sticker, such as animation effects, interactivity, filters, etc. Among them, in order to improve the configuration efficiency and enhance the flexibility of sticker configuration, a variety of sticker capabilities are preset in advance to provide more choices for the creation of sticker, thereby achieving diversified sticker effects. Among them, various sticker capabilities include, but are not limited to, the following capabilities: basic gesture configuration capabilities and external gesture collaboration capabilities. Basic gesture configuration capabilities include but are not limited to: the ability to respond to touch, sticker movement, sticker rotation, sticker scaling, etc. External gesture collaboration capabilities include but are not limited to: sticker content editing, sticker duration editing, sticker safe zone boundary line, sticker deletion, sticker bubble, sticker auxiliary box, sticker guidance, etc.

In order to enable the obtained sticker to meet the creation requirement, the creation requirement is analyzed, and then the target sticker capability corresponding to the creation requirement is determined from a plurality of preset sticker capabilities, so that targeted sticker configuration may be performed subsequently.

In step S103, the first model parameter is updated based on the target sticker capability to obtain the second model parameter.

According to the target sticker capability, the parameters corresponding to the target sticker capability may be clarified, and then the parameter in the first model parameter may be adjusted by parameter adjustment, so that the second model parameter obtained after adjustment may have the target sticker capability. For example, if the target sticker ability is to add animation effects, parameters such as sticker's frame rate and key frame need to be adjusted.

In step S104, a first target sticker corresponding to the sticker to be created is generated by rendering of the second model parameter.

Using rendering engine or related tools, the second model parameter may be converted into visual first target sticker, so that it may be used in practical applications, thus facilitating the subsequent evaluation and adjustment of the produced first target sticker. Among them, the rendering process may include processing of lighting, material, texture, etc., to generate realistic sticker effects.

According to the method of generating the sticker provided by the present embodiment, the target sticker capability that needs to be targeted configured for the sticker to be created is determined from a plurality of preset sticker capabilities according to the creation requirements of the sticker to be created, and then the first model parameter to be created is targeted updated by parameter adjustment, and the corresponding first target sticker is generated by performing rendering on the updated second model parameter, thereby making the configuration mode of the sticker capability more flexible and convenient, effectively reducing the occurrence of repeated development and configuration, thereby effectively improving the configuration efficiency of the sticker, and meeting the needs of different scenarios and users.

In some alternative embodiments, the target sticker capability includes a first execution capability and a first interception capability, and the above step S103 includes:

Step a1: determining a first parameter corresponding to the first execution capability and a second parameter corresponding to the first interception capability;

Step a2, based on the first parameter and the second parameter, updating the first model parameter to obtain the second model parameter.

The first execution capability may be understood as a sub-capability for responding to the execution of the target sticker capability on the corresponding sticker, and the first interception capability may be understood as a sub-capability for intercepting the execution of the target sticker capability on the corresponding sticker. For example, the first execution capability may be used to detect events such as creation, update, and deletion of sticker, and perform corresponding operations as needed. The first interception capability may be used to intercept specific operations on sticker, such as prohibiting deletion, restricting access, etc., to ensure the security and integrity of sticker.

Specifically, after the target sticker capability is clarified, the first model parameter is analyzed to clarify factors related to the first execution capability and the first interception capability, and then the first parameter corresponding to the first execution capability and the second parameter corresponding to the first interception capability are determined.

According to the currently clear first parameters and second parameters, the first model parameters are updated targeted, so that the sticker model corresponding to the obtained second model parameter can better adapt to the execution and interception requirements of the target sticker capability, thereby helping to improve the performance and accuracy of the sticker model to better achieve the target sticker capability.

In other alternative embodiments, the method of generating the sticker further includes: displaying the first target sticker on the display interface in response to the first interactive operation that is received, which can improve the visual experience of the user, make the display interface more attractive, and further help to enhance the content expression ability of the display interface, facilitate the user to interact with the display interface more intuitively, increase the sense of participation and fun, and thus help to improve the user's user experience.

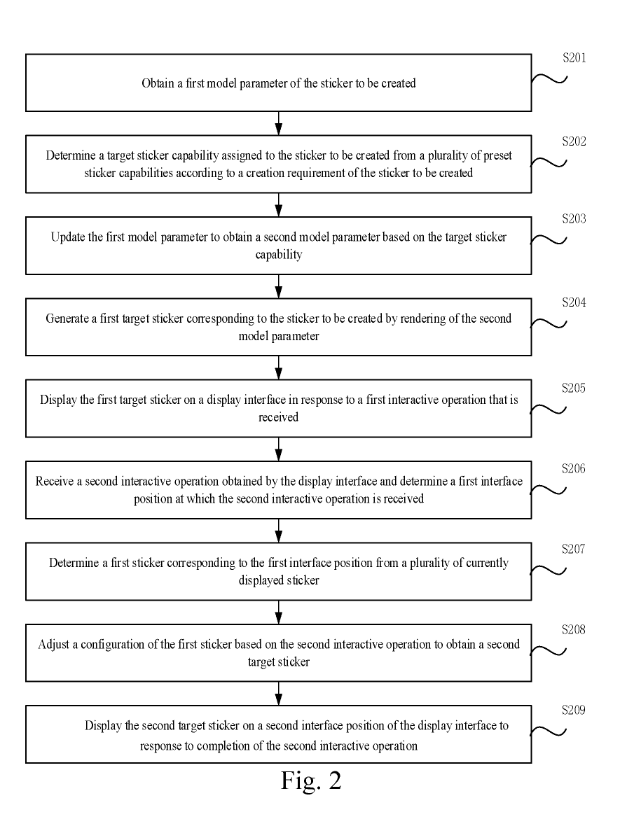

In this embodiment, a method of generating a sticker is provided, which may be used in electronic device, such as mobile phones, tablet computers, etc. FIG. 2 is a flowchart of the method of generating the sticker according to an embodiment of the present disclosure, and as shown in FIG. 2, the flow includes the following steps.

In step S201, a first model parameter associated with a sticker to be created is obtained.

In step S202, a target sticker capability configured to the sticker to be created is determined from a plurality of preset sticker capabilities according to the creation requirement of the sticker to be created.

In step S203, the first model parameter is updated based on the target sticker capability to obtain the second model parameter.

In step S204, a first target sticker corresponding to the sticker to be created is generated by rendering the second model parameter.

In step S205, the first target sticker is displayed on the display interface in response to the first interactive operation that is received.

In step S206, the second interactive operation obtained by display interface is received, and the first interface position for receiving the second interactive operation is determined.

The second interactive operation may be triggered based on a particular gesture of the user. For example, the second interactive operation is triggered by a gesture such as click, drag, scaling, etc.

When the second interactive operation acting on the display interface is received, it indicates that the user currently needs to interact with the display interface. Therefore, in order to improve the response efficiency, the first interface position for receiving the second interactive operation is determined, and the corresponding interaction object to be responded is clarified through the first interface position.

In step S207, a first sticker corresponding to the first interface position is determined from the plurality of currently displayed stickers.

Among them, the plurality of stickers include the first target sticker. That is, the plurality of sticker currently displayed on the display interface are all stickers that have been created and generated. The generation principle of each sticker is the same as the generation principle of the first target sticker described above, and the description thereof will not be repeated here.

In order to improve the accuracy of the interaction, whether the position of each sticker on the display interface overlaps with the position of the first interface is sequentially determined from the plurality of currently displayed stickers, and then the sticker overlapping with the position of the first interface is used as the first sticker, and the interaction object to be responded to the second interactive operation is clarified.

In some alternative embodiments, the above step S207 includes:

In step b1, selecting at least one sticker whose display position overlaps with the first interface position as a candidate sticker based on a display position of each sticker and the first interface position;

In step b2, determining that the candidate sticker is the first sticker corresponding to the first interface position in response to the second interactive operation being a valid operation of the candidate sticker.

Specifically, all sticker currently displayed on display interface is traversed. The display position, for example, specifically coordinates or area information, of each sticker is obtained, respectively. The display position is compared with the first interface position to determine whether there is an overlap of positions. If the display position of the current sticker overlaps with the first interface position, the sticker is used as a candidate sticker to reduce the range of subsequent processing through sticker selection, thereby improving response efficiency.

Since each candidate sticker has its corresponding responsive interactive operation, in order to avoid the occurrence of erroneous operation or erroneous response, the corresponding effective operation type or rule is determined for each candidate sticker. Judging whether the second interactive operation meets the valid operating conditions of the candidate sticker. If so, the candidate sticker is determined as the first sticker corresponding to the first interface position to improve the accuracy and efficiency of the interaction.

In some optional examples, when the candidate sticker includes a plurality of candidate stickers, the above step b2 includes the following steps.

In step b21: determining a display hierarchy order of a plurality of candidate stickers;

In step b22: matching the second interactive operation with an interactive operation set corresponding to the candidate sticker hierarchy by hierarchy according to the display hierarchy order to obtain a matching result;

In step b23, determining that the second interactive operation is a valid operation of the candidate sticker, and determining that the candidate sticker is the first sticker, in response to the matching result indicating that the interactive operation set corresponding to the candidate sticker includes the second interactive operation.

Specifically, when the candidate sticker includes a plurality of candidate stickers, erroneous recognition or erroneous processing may occur. In this case, in order to improve the accuracy of interaction, the display hierarchy order of the plurality of candidate stickers is determined to clarify the display priority of each candidate sticker.

The interactive operation set is at least one interactive operation supported by the corresponding candidate sticker.

According to the display hierarchical order, starting from the top of the display hierarchical order, the second interactive operation and the interactive operation set corresponding to the current corresponding candidate sticker are matched hierarchy by hierarchy. If the matching result indicates that the interactive operation set corresponding to the candidate sticker includes the second interactive operation, the second interactive operation is determined as an valid operation of the candidate sticker, and the candidate sticker is determined as the first sticker, and the candidate sticker may be targeted adjusted based on the second interactive operation, which is beneficial to improving the accuracy and efficiency of the operation.

In some examples, in order to improve the response capability of the interactive operation, when the current candidate sticker is determined to be the first sticker, the process of continuing downward matching is stopped, so that the second interactive operation can be quickly responded to and the interactive experience of the user can be improved.

In other alternative examples, the above step b2 further includes the following steps.

In step b24, if the matching result indicates that the interactive operation set corresponding to the candidate sticker does not include the second interactive operation, determining that the second interactive operation is an invalid operation of the candidate sticker;

In step b25, the second interactive operation is matched with interactive operation set corresponding to the candidate sticker in next hierarchy, and the first sticker is determined according to the obtained matching result.

Specifically, if the matching result indicates that the interactive operation set of the candidate sticker does not include the second interactive operation, it indicates that the candidate sticker is not an interaction object to be responded to the second interactive operation, and then it is determined that the second interactive operation is an invalid operation of the candidate sticker, so as to avoid erroneous processing of the unsupported operation.

In order to improve the accuracy of interactive operation, the second interactive operation and interactive operation set corresponding to the candidate sticker in next hierarchy is continuously matched to ensure that an effective sticker corresponding to the second interactive operation can be found according to the obtained matching result, thereby enhancing the corresponding robustness and stability of the system.

In yet other alternative examples, step b2 further includes the following steps.

In step b26, if each of the interactive operation set corresponding to the candidate sticker does not include the second interactive operation, it is determined that the second interactive operation is an invalid operation, and no response is performed. That is, if each of the interactive operation set corresponding to the candidate sticker does not include the second interactive operation, it indicates that the interaction object corresponding to the second interactive operation is not a sticker, and thus the second interactive operation is not responded to, thereby helping to improve the performance of the system and the user experience.

In step S208: Based on the second interactive operation, the configuration of the first sticker is adjusted to obtain the second target sticker.

According to the type and parameters of the second interactive operation, it is possible to determine a mode that the configuration of the first sticker needs to be adjusted, such as changing the size, color, shape, and the like.

According to the clear mode of adjustment, the configuration of the first sticker is modified accordingly to obtain the adjusted second target sticker, which can realize the personalized adjustment of the sticker by users and meet the needs of users, thereby helping to increase the diversity and flexibility of sticker.

In some alternative embodiments, the above step S208 includes the following steps.

In step c1, a first sticker capability corresponding to the second interactive operation is determined according to a preset correspondence between an interactive operation and a sticker capability.

In step c2: the configuration of the first sticker is adjusted based on the third parameter corresponding to the first sticker capability to obtain the second target sticker.

Specifically, through the preset correspondence between the interactive operation and the sticker capability, the first sticker capability corresponding to the second interactive operation can be quickly determined, and then the third parameter corresponding to the first sticker capability can be obtained, and the configuration of the first sticker can be adjusted according to these parameters, so that the second target sticker obtained after adjustment can have the first sticker capability, thereby achieving the purpose of meeting the individual needs of users and helping to provide richer and more diversified sticker effects.

In some alternative examples, the above step c2 includes the following steps.

In step c21: an initial model parameter of the first sticker and current view configuration are obtained;

In step c22, the initial model parameter is adjusted based on the third parameter to obtain the target model parameter;

In step c23, the current view configuration is updated based on the target model parameter to obtain the second target sticker.

Specifically, the initial model parameters refer to basic attributes of the first sticker, such as size, shape, color, and the like. The current view configuration refers to the specific settings of the first sticker on the current display interface, such as position, rotation angle, scale/scaling ratio, etc.

Through the third parameter, the mode of adjusting the initial model parameter may be clearly defined, and then the targeted modification of the initial model parameter may be realized, so that the obtained target model parameter may have the first sticker capability.

In order to represent the adjusted first sticker concretely, rendering processing is performed on the target model parameters to achieve the purpose of updating the current view configuration, so that the obtained second target sticker may represent the adjusted sticker effect more intuitively, thereby realizing the customized setting of the second target sticker.

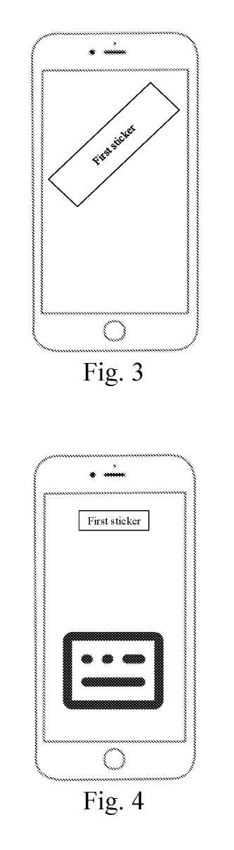

In some alternative implementation scenarios, taking the first sticker shown in FIG. 3 as an example, if the second interactive operation is responded to the first sticker, it is necessary to restore the first sticker to the editing state as shown in FIG. 4 according to the initial model parameters of the first sticker. Through the third parameter of the first sticker capability corresponding to the second interactive operation, the initial model parameter of the editing state is adjusted to obtain the target model parameter, and the current view configuration is updated based on the target model parameter to obtain the second target sticker finally displayed.

In step S209, the second target sticker is displayed on the second interface position of the display interface to response to completion of the second interactive operation.

By drawing the second target sticker on the second interface position of the display interface, the response to the second interactive operation can be fed back in an intuitive manner, thereby facilitating user perception and subsequent targeted adjustment by users.

In some optional examples, the above step S209 includes the following steps.

In step d1, according to the configuration of the second target sticker, a display period of the second target sticker on the second interface position of the display interface is determined;

In step d2, controlling the target sticker to be displayed on the second interface position of the display interface during the display period;

In step d3, in response to the current time exceeding the display period, the configuration of the second target sticker is updated to hide display of the second target sticker on the second interface position of the display interface.

Specifically, by analyzing the configuration of the second target sticker, the pertinent information of the display period can be extracted therefrom, and then the display period of the second target sticker on the second interface position can be determined, so as to facilitate subsequent targeted adjustment of the view effect of the second target sticker.

The second target sticker is displayed on the second interface position of the display interface during the display period. Checks if the current time is within the display period. If the current time is within the display period, the second target sticker is displayed on the second interface position, and the view effect of the second target sticker is maintained until the end of the display period, so as to improve the visibility and attention of the user to the target sticker.

If the current time exceeds the display period, the configuration of the second target sticker will be updated to hide its display on the second interface position of the display interface, thereby helping to keep the display interface clean and clear, and helping to improve the user experience.

By determining the display period, controlling the display and hiding, the dynamic display management of the second target sticker on the display interface is realized, and then the flexibility of user experience and display effect can be effectively improved.

The method of generating the sticker according to the present embodiment generates a first target sticker by obtaining first model parameter associated with a sticker to be created, determining a target sticker capability according to a creation requirement, and updating the model parameter, thereby satisfying a user's personalized requirement for sticker. Displaying the first target sticker on the interface in response to the first interactive operation helps to improve the user's sense of engagement and interactivity. By receiving the second interactive operation and determining the corresponding first sticker, and adjusting the configuration of the first sticker to obtain the second target sticker, the customization requirements of the user can be further satisfied. Finally, displaying the second target sticker in a specific position helps to enhance the user's sense of control over the sticker and the flexibility of operation, thereby effectively improving the user experience and enriching the functions and application scenarios of the sticker.

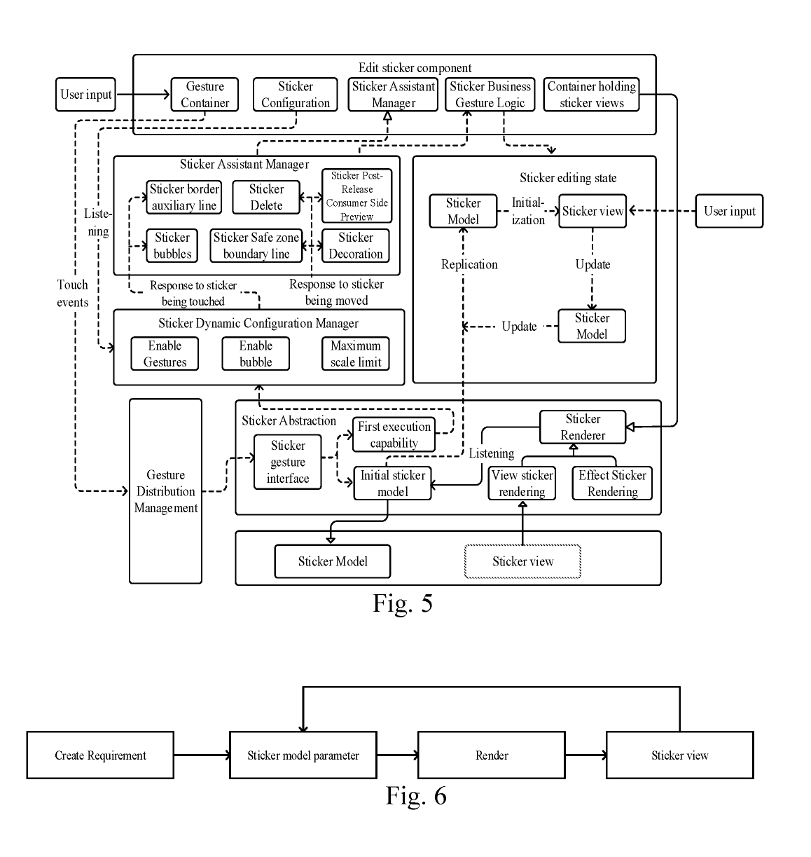

As one or more specific application embodiments of the embodiments of the present disclosure, a sticker framework shown in FIG. 5 is provided for supporting the creation and generation of sticker. The sticker framework includes gesture distribution management, sticker abstraction, sticker dynamic configuration manager, sticker auxiliary manager, sticker editing state and editing sticker components. When the user interacts with the sticker on the display interface through a gesture, the gesture distribution management automatically recognizes the first sticker capability corresponding to the interactive operation triggered by the gesture from the sticker dynamic configuration manager through the first execution capability, and then determines the first sticker to be targeted configured in combination with the sticker auxiliary manager, and triggers a touch event. Entering the sticker editing state, combining the initial model parameters corresponding to the sticker model of the first sticker and the current view configuration, adjusting the initial model parameters corresponding to the sticker model based on the third parameter corresponding to the first sticker capability to obtain the target model parameters, thereby updating the current view configuration based on the target model parameters, and obtaining the second target sticker finally displayed on the display interface.

That is, as shown in FIG. 6, the principle followed by the above-mentioned sticker framework may be simplified and understood as the principle of sticker model parameter-driven sticker view display and one-way circulation of data flow. The model parameters of the sticker model are adjusted through the parameters corresponding to the sticker capability, which affects the final display effect of the sticker corresponding to the sticker capability. For example, sticker capabilities include but are not limited to: sticker Safe Zone boundary line, sticker Guide, sticker Bubble, sticker Post-Release Consumer Side Preview, sticker Delete, and sticker Border Auxiliary Line, etc.

The present embodiment also provides a sticker generation device for implementing the above-described embodiment and the preferred embodiment, and the description thereof will not be repeated. As used below, the term "module" may be a combination of software and/or hardware that implements a predetermined function. Although the apparatus described in the following embodiments is preferably implemented in software, implementations of hardware, or combinations of software and hardware, are also possible and contemplated.

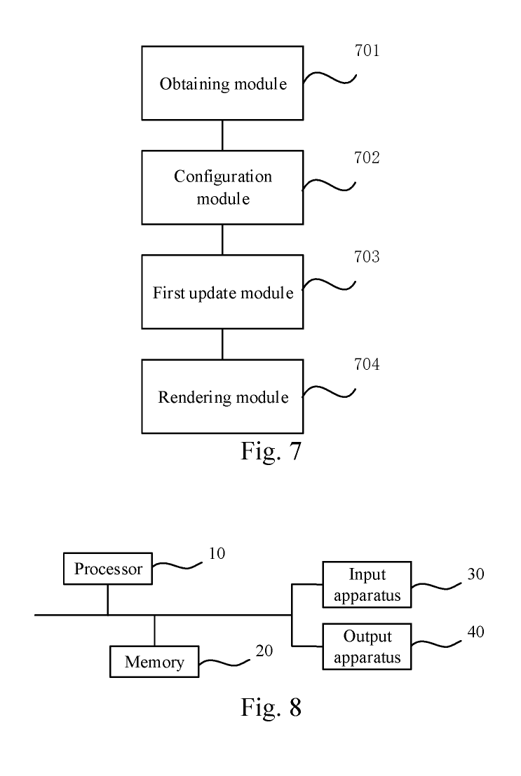

The present embodiment provides a sticker generation device, as shown in FIG. 7, including:

Obtaining module 701 configured to obtain first model parameter associated with a sticker to be created;

A configuration module 702 configured to determine, from a plurality of preset sticker capabilities, a target sticker capability configured to the sticker to be created according to a creation requirement of the sticker to be created;

A first update module 703 configured to update the first model parameter based on the target sticker capability to obtain second model parameter;

A rendering module 704 configured to generate a first target sticker corresponding to the sticker to be created by rendering the second model parameter.

In some alternative embodiments, the target sticker capability includes a first execution capability and a first interception capability; The first update module includes:

A first determination unit configured to determine a first parameter corresponding to the first execution capability and a second parameter corresponding to the first interception capability; and

A second update unit configured to update the first model parameter based on the first parameter and the second parameter to obtain the second model parameter.

In some alternative embodiments, the device further includes:

A first display module configured to display a first target sticker on the display interface in response to the first interactive operation that is received.

In some alternative embodiments, the device further includes:

A first processing module configured to receive a second interactive operation obtained through the display interface and determine a first interface position at which the second interactive operation is received;

A second processing module configured to determine a first sticker corresponding to the first interface position from a plurality of currently displayed sticker, where the plurality of sticker including a first target sticker;

A second update module configured to adjust a configuration of the first sticker based on the second interactive operation to obtain a second target sticker; and

A second display module configured to display a second target sticker on a second interface position of the display interface to response to completion of the second interactive operation.

In some alternative embodiments, the second processing module includes:

A first selecting unit configured to select at least one sticker, whose display position overlaps with the first interface position, as a candidate sticker based on a display position of each sticker and the first interface position; and

A first processing unit configured to determine that the candidate sticker is the first sticker corresponding to the first interface position in response to the second interactive operation being a valid operation of the candidate sticker.

In some alternative embodiments, when the candidate sticker includes a plurality of candidate stickers, the first processing unit includes:

A second determination unit configured to determine a display hierarchy order of the plurality of candidate sticker;

A second selecting unit configured to match the second interactive operation with an interactive operation set corresponding to the candidate sticker hierarchy by hierarchy according to the display hierarchy order to obtain a matching result; and

A first execution unit configured to determine that the second interactive operation is a valid operation of the candidate sticker and determine that the candidate sticker is the first sticker, in response to the matching result indicating that the interactive operation set corresponding to the candidate sticker includes the second interactive operation.

In some alternative embodiments, the first processing unit further includes:

A third determination unit configured to determine that the second interactive operation is an invalid operation of the candidate sticker, in response to the matching result indicating that the interactive operation set corresponding to the candidate sticker does not include the second interactive operation; and

A second execution unit configured to match the second interactive operation with an interactive operation set corresponding to the candidate sticker in next hierarchy to determine the first sticker according to a matching result that is obtained.

In some alternative embodiments, the first processing unit further includes:

A third execution unit configured to determine that the second interactive operation is an invalid operation and not to response, in response to each of the interactive operation set corresponding to the candidate sticker does not include the second interactive operation.

In some alternative embodiments, the second update module includes:

A fourth determination unit configured to determine determining a first sticker capability corresponding to the second interactive operation according to a preset correspondence between an interactive operation and a sticker capability; and

A first adjustment unit configured to adjust the configuration of the first sticker based on a third parameter corresponding to the first sticker capability to obtain the second target sticker.

In some alternative embodiments, the first adjustment unit includes:

A second processing unit configured to obtain initial model parameters of the first sticker and a current view configuration;

A parameter adjusting unit configured to adjust the initial model parameter based on the third parameter to obtain the target model parameter; and

A third update unit configured to update the current view configuration based on the target model parameters to obtain the second target sticker.

In some alternative embodiments, the second display module includes:

A fourth determination unit configured to determine a display period of the second target sticker on the second interface position of the display interface according to a configuration of the second target sticker;

A third processing unit configured to control the target sticker to be displayed on the second interface position of the display interface during the display period; and

A fourth update unit configured to update the configuration of the second target sticker to hide display of the second target sticker on the second interface position of the display interface in response to current time exceeding the display period.

Further functional descriptions of the above-described modules and units are the same as those of the above-described corresponding embodiments, and will not be repeatedly described herein.

The sticker generation device in this embodiment is presented in the form of a functional unit, and the unit here refers to an ASIC (Application Specific Integrated Circuit) circuit, processor and memory that execute one or more software or fixed programs, and/or other devices that can provide the above-described functions.

An embodiment of the present disclosure further provides an electronic device including the sticker generation device shown in FIG. 7.

Referring to FIG. 8, FIG. 8 is a schematic structural diagram of an electronic device provided by an alternative embodiment of the present disclosure. As shown in FIG. 8, the electronic device includes one or more processor 10, memory 20, and interfaces for connecting various components, including a high-speed interface and a low-speed interface. The various components are communicatively connected to each other using different buses and may be mounted on a common motherboard or otherwise as desired. The processor may process instructions executed within the electronic device, including instructions stored in or on the memory to display graphical information of the GUI on an external input/memory, such as a display device coupled to the interface. In some alternative embodiments, a plurality of processor and/or a plurality of buses may be used with a plurality of memory and a plurality of memory if desired. Likewise, multiple electronic device devices may be connected, with each device providing some of the necessary operations (e.g., as an array of servers, a set of blade servers, or a multi-processor system). In FIG. 8, one processor 10 is taken as an example.

The processor 10 may be central processing unit, Cyber processor, or a combination thereof. Among them, the processor 10 may further include a hardware chip. The hardware chip may be an application specific integrated circuit, a programmable logic device, or a combination thereof. The programmable logic device may be a complex programmable logic device, a field programmable logic gate array, a general purpose array logic, or any combination thereof.

The memory 20 stores instructions executable by at least one processor 10 to cause the at least one processor 10 to perform the method illustrated in the above embodiment.

The memory 20 may include a stored program area and a stored data area, wherein the stored program area may store operating system and application required for at least one function; The storage data area may store data or the like created in accordance with the use of electronic device. Furthermore, the memory 20 may include a high-speed random access memory, and may also include a non-transitory memory, such as at least one magnetic disk memory device, a flash memory device, or other non-transitory solid state memory device. In some alternative embodiments, the memory 20 may optionally include a memory located remotely relative to the processor 10 to which the remote memory may be connected via a network. Examples of the above networks include, but are not limited to, the Internet, an enterprise intranet, a local area network, a mobile communication network, and combinations thereof.

The memory 20 may include a volatile memory, for example, a random access memory. The memory may also include a non-volatile memory, for example, a flash memory, a hard disk, or a solid state hard disk; The memory 20 may also include a combination of the above-described kinds of memory.

The electronic device also includes input apparatus 30 and output apparatus 40. The processor 10, the memory 20, the input apparatus 30, and the output apparatus 40 may be connected by a bus or other means, as illustrated in FIG. 8 by a bus connection.

The input apparatus 30 may receive input numeric or character information and generate key signal inputs related to user settings and functional controls of the electronic device, such as a touchscreen, keypad, mouse, trackpad, touchpad, pointer lever, one or more mouse buttons, trackball, joystick, etc. The output apparatus 40 may include a display device, an auxiliary lighting device (e.g., an LED), a tactile feedback device (e.g., a vibration motor), and the like. The above display devices include, but are not limited to, liquid crystal displays, light emitting diodes, displays, and plasma displays. In some alternative embodiments, the display device may be a touchscreen.

Embodiments of the present disclosure also provide a computer-readable storage medium, and the above-described methods according to embodiments of the present disclosure may be implemented in hardware, firmware, or as computer code that may be recorded in storage medium, or downloaded over a network and is originally stored in a remote storage medium or a non-transitory machine-readable storage medium and to be stored in a local storage medium, so that the methods described herein may be processed by such software stored on a processor using a general-purpose computer, a special-purpose storage medium, or programmable or special-purpose hardware. Among them, the storage medium may be magnetic disk, optical disk, read-only memory, random access memory, flash memory, hard disk or solid-state hard disk, etc.; Further, the storage medium may also include a combination of the above-described kinds of memory. It will be appreciated that a computer, processor, microprocessor controller, or programmable hardware includes a storage component that may store or receive software or computer code that, when accessed and executed by the computer, processor, or hardware, implements the methods illustrated in the above embodiments.

Part of the present invention may be applied to computer program product, such as computer program instructions, when executed by a computer, by operation of which the method and/or technical solution according to the present invention can be invoked or provided. Those skilled in the art will understand that the existence forms of computer program instructions in a computer-readable medium include, but are not limited to, source files, executable file, installation package files, etc. Accordingly, the manner in which computer program instructions are executed by a computer includes, but is not limited to: the computer directly executes the instructions, or the computer compiles the instructions and then executes the corresponding compiled program, or the computer reads and installs the instructions and then executes the corresponding post-installation program. Here, the computer-readable medium may be any available computer-readable storage medium or communication medium accessible by a computer.

It can be understood that before using the technical solutions disclosed in each embodiment of the present disclosure, users should be informed of the types, usage scope, usage scenarios, etc. of the personal information involved in the present disclosure in an appropriate manner in accordance with relevant laws and regulations, and authorization from the users should be obtained.

For example, in response to receiving an active request from the user, prompt information is sent to the user to explicitly prompt the user that the operation it requests to perform will require the acquisition and use of the user's personal information. Accordingly, the user can autonomously select whether or not to provide personal information to software or hardware such as electronic device, application, a server, or storage medium that performs the operation of the technical solution of the present disclosure according to prompt information.

As an optional but non-limiting implementation, in response to receiving an unsolicited request from the user, the manner of sending prompt information to the user may be, for example, the manner of pop-up window, and the pop-up window may be presented in text in the prompt information. In addition, the pop-up window can also carry an optional control for users to choose "agree" or "disagree" to provide personal information to electronic device.

It is to be understood that the above-described procedures of notifying and obtaining user authorization are merely illustrative and do not limit the implementation forms of the present disclosure, and other methods satisfying relevant laws and regulations may also be applied to the implementation forms of the present disclosure.

Although embodiments of the present disclosure have been described in conjunction with the accompanying drawings, various modifications and variations can be made by those skilled in the art without departing from the spirit and scope of the present disclosure, and such modifications and variations fall within the scope defined by the appended claims.

1. A method of generating a sticker, comprising:
obtaining a first model parameter associated with a sticker to be created;
determining, from a plurality of preset sticker capabilities, a sticker capability configured to the sticker to be created according to a creation requirement of the sticker to be created;
updating the first model parameter based on the sticker capability to obtain a second model parameter; and
generating a first sticker corresponding to the sticker to be created by rendering of the second model parameter.

2. The method according to claim 1, wherein the sticker capability comprises a first execution capability and a first interception capability,
wherein the updating the first model parameter based on the sticker capability to obtain a second model parameter, comprises:
determining a first parameter corresponding to the first execution capability and a second parameter corresponding to the first interception capability; and
updating the first model parameter based on the first parameter and the second parameter to obtain the second model parameter.

3. The method according to claim 1, further comprising:
displaying the first sticker on a display interface in response to a first interactive operation that is received.

4. The method according to claim 3, further comprising:
receiving a second interactive operation obtained by the display interface and determining a first interface position at which the second interactive operation is received;
determining a first sticker corresponding to the first interface position from a plurality of currently displayed sticker, wherein the plurality of currently displayed sticker comprising the first sticker;
adjusting a configuration of the first sticker based on the second interactive operation to obtain a second sticker; and
displaying the second sticker on a second interface position of the display interface to response to completion of the second interactive operation.

5. The method according to claim 4, wherein the determining a first sticker corresponding to the first interface position from a plurality of currently displayed sticker comprises:
selecting at least one sticker, whose display position overlaps with the first interface position, as a candidate sticker based on a display position of each sticker and the first interface position;
determining that the candidate sticker is the first sticker corresponding to the first interface position in response to the second interactive operation being a valid operation of the candidate sticker.

6. The method according to claim 5, wherein, when the candidate sticker comprises a plurality of candidate stickers, the determining that the candidate sticker is the first sticker corresponding to the first interface position in response to the second interactive operation being a valid operation of the candidate sticker, comprises:
determining a display hierarchy order of the plurality of the candidate stickers;
matching the second interactive operation with an interactive operation set corresponding to the candidate sticker hierarchy by hierarchy according to the display hierarchy order to obtain a matching result; and
determining that the second interactive operation is a valid operation of the candidate sticker and determining that the candidate sticker is the first sticker, in response to the matching result indicating that the interactive operation set corresponding to the candidate sticker comprises the second interactive operation.

7. The method according to claim 6, wherein, the determining that the candidate sticker is the first sticker corresponding to the first interface position in response to the second interactive operation being a valid operation of the candidate sticker, further comprises:
determining that the second interactive operation is an invalid operation of the candidate sticker, in response to the matching result indicating that the interactive operation set corresponding to the candidate sticker does not comprise the second interactive operation; and
matching the second interactive operation with an interactive operation set corresponding to the candidate sticker in next hierarchy to determine the first sticker according to a matching result that is obtained.

8. The method according to claim 6, wherein the determining a first sticker corresponding to the first interface position from a plurality of currently displayed sticker further comprises:
determining that the second interactive operation is an invalid operation and not to response, in response to each of the interactive operation set corresponding to the candidate sticker does not comprise the second interactive operation.

9. The method according to claim 4, wherein the adjusting a configuration of the first sticker based on the second interactive operation to obtain a second sticker comprises:
determining a first sticker capability corresponding to the second interactive operation according to a preset correspondence between an interactive operation and a sticker capability; and
adjusting the configuration of the first sticker based on a third parameter corresponding to the first sticker capability to obtain the second sticker.

10. The method according to claim 9, wherein the adjusting the configuration of the first sticker based on a third parameter corresponding to the first sticker capability to obtain the second sticker, comprises:
obtaining initial model parameters of the first sticker and a current view configuration;
adjusting the initial model parameter based on the third parameter to obtain a model parameter; and
updating the current view configuration based on the model parameters to obtain the second sticker.

11. The method according to claim 4, wherein the displaying the second sticker on a second interface position of the display interface comprises:
determining a display period of the second sticker on the second interface position according to a configuration of the second sticker;
controlling the second sticker to be displayed on the second interface position of the display interface during the display period; and
updating the configuration of the second sticker to hide display of the second sticker on the second interface position of the display interface in response to current time exceeding the display period.

12. A electronic device comprising:
a memory, and
at least one processor being communicatively connected to the memory, wherein the at least one processor is configured to execute computer instructions stored in the memory to perform a method of generating a sticker, the method comprises:
obtaining a first model parameter associated with a sticker to be created;
determining, from a plurality of preset sticker capabilities, a sticker capability configured to the sticker to be created according to a creation requirement of the sticker to be created;
updating the first model parameter based on the sticker capability to obtain a second model parameter; and
generating a first sticker corresponding to the sticker to be created by rendering of the second model parameter.

13. The electronic device according to claim 12, wherein the sticker capability comprises a first execution capability and a first interception capability,
wherein the updating the first model parameter based on the sticker capability to obtain a second model parameter, comprising:
determining a first parameter corresponding to the first execution capability and a second parameter corresponding to the first interception capability; and
updating the first model parameter based on the first parameter and the second parameter to obtain the second model parameter.

14. The electronic device according to claim 12, the processor is further configured to:
display the first sticker on a display interface in response to a first interactive operation that is received.

15. The electronic device according to claim 14, the processor is further configured to:
receive a second interactive operation obtained by the display interface and determine a first interface position at which the second interactive operation is received;
determine a first sticker corresponding to the first interface position from a plurality of currently displayed sticker, wherein the plurality of currently displayed sticker comprising the first sticker;
adjust a configuration of the first sticker based on the second interactive operation to obtain a second sticker; and
display the second sticker on a second interface position of the display interface to response to completion of the second interactive operation.

16. The electronic device according to claim 15, wherein the determining a first sticker corresponding to the first interface position from a plurality of currently displayed sticker comprises:
selecting at least one sticker, whose display position overlaps with the first interface position, as a candidate sticker based on a display position of each sticker and the first interface position;
determining that the candidate sticker is the first sticker corresponding to the first interface position in response to the second interactive operation being a valid operation of the candidate sticker.

17. The electronic device according to claim 16, wherein, when the candidate sticker comprises a plurality of candidate stickers, the determining that the candidate sticker is the first sticker corresponding to the first interface position in response to the second interactive operation being a valid operation of the candidate sticker, comprises:
determining a display hierarchy order of the plurality of the candidate stickers;
matching the second interactive operation with an interactive operation set corresponding to the candidate sticker hierarchy by hierarchy according to the display hierarchy order to obtain a matching result; and
determining that the second interactive operation is a valid operation of the candidate sticker and determining that the candidate sticker is the first sticker in response to the matching result indicating that the interactive operation set corresponding to the candidate sticker comprises the second interactive operation.

18. The electronic device according to claim 15, wherein the adjusting a configuration of the first sticker based on the second interactive operation to obtain a second sticker comprises:
determining a first sticker capability corresponding to the second interactive operation according to a preset correspondence between an interactive operation and a sticker capability; and
adjusting the configuration of the first sticker based on a third parameter corresponding to the first sticker capability to obtain the second sticker.

19. The electronic device according to claim 15, wherein the displaying the second sticker on a second interface position of the display interface comprises:
determining a display period of the second sticker on the second interface position according to a configuration of the second sticker;
controlling the second sticker to be displayed on the second interface position of the display interface during the display period; and
updating the configuration of the second sticker to hide display of the second sticker on the second interface position of the display interface in response to current time exceeding the display period.

20. A non-transitory computer-readable storage medium, wherein computer instructions are stored on the computer-readable storage medium for causing a computer to perform a method of generating a sticker, the method comprises:
obtaining a first model parameter associated with a sticker to be created;
determining, from a plurality of preset sticker capabilities, a sticker capability configured to the sticker to be created according to a creation requirement of the sticker to be created;
updating the first model parameter based on the sticker capability to obtain a second model parameter; and
generating a first sticker corresponding to the sticker to be created by rendering of the second model parameter.
